(19) United States
(12) Patent Application Publication
(10) Pub. No.: US 2009/0271914 A1
(43) Pub. Date: Nov. 5, 2009

(54) Flocked elastomeric coated garments

(75) Inventor: Hans BAUER, Balingen (DE)

Correspondence Address: MORGAN LEWIS & BOCKIUS LLP, 1111 PENNSYLVANIA AVENUE NW, WASHINGTON, DC, 20004, US

(73) Assignee: NTT New Textile Technologies GmbH

(21) Appl. No.: 12/149,504

(22) Filed: May 2, 2008

(51) Int. Cl. A41B 9/00; B26D 7/06

(52) U.S. Cl. 2/401; 156/256

(57) ABSTRACT

A new and improved garment includes support bands fabricated from an elastomeric adhesive and flocking with one end of the flocking fibers embedded within the elastomeric adhesive. In addition, a process for producing garments with flocking fibers manufactured using electrostatic or mechanical devices.

### BACKGROUND OF THE INVENTION

1. Field of the Invention

The invention relates to garments having support bands containing an elastomeric adhesive and flocking and a method for producing those garments.

2. Description of the Prior Art

In most previously known undergarments, seam connections are required in order to connect the different layers or parts of the undergarment with one another. However such seams have the disadvantage that the seam material has an elastic behavior which differs from the textile material itself such that the wearing properties are impaired. Further, the seams and/or elastic bands sewn to the undergarments typically present a significantly thicker area that can result in discomfort to the wearer and visible lines on the outside of form-fitting clothes. Fabricating the elastic band and sewing it onto the garment can also be costly and time consuming.

While some undergarments may be formed without elastic bands sewn on, they often suffer the disadvantage that the support and bearing force is strongly impaired since the elasticity is provided by the fabric alone and not by other additional means.

Additionally, although undergarments have been produced with, e.g., silicone rubber coated sections to provide support and adhere to the skin, the rubber tends to be uncomfortable where it contacts the skin. There exists a need for waistbands and other elastic portions of apparel that do not have separately connected seams, and that are more comfortable to the wearer than garments having rubber to skin contact.

### SUMMARY OF THE INVENTION

The invention is therefore generally based on providing garments with elastomeric support that is not sewn to the garment and that is comfortable against the wearer's skin.

In one embodiment of the present invention, a garment includes a stretchable fabric, an elastomeric adhesive coating a portion of the inside of the fabric that would face the skin of a person wearing the garment, and fiber flocking with one end of each fiber embedded within the elastomeric adhesive.

Another embodiment of the present invention is a method of fabricating a garment including cutting one or more panels of a stretchable fabric to form the garment, coating a portion of the inside of the fabric that would face the skin of a person wearing the garment with an elastomeric adhesive, and embedding one end of each fiber of fiber flocking within the elastomeric adhesive. The fiber flocking may be attracted to the adhesive by electrostatic charges.

The invention will be explained in further detail in conjunction with drawings representing various embodiments. In the drawings and in the following descriptions, further characteristics and advantages associated with the invention are evident.

### BRIEF DESCRIPTION OF THE DRAWINGS

FIG. 1 shows a garment according to the present invention.

FIG. 2 shows a silkscreen configuration for applying adhesive coating according to one aspect of the present invention.

FIG. 3 shows a top view of the silk screen shown in FIG. 3.

FIG. 4 shows a cross section taken through the waistband section of the garment shown in FIG. 1.

FIG. 5 shows the application of charge and attraction of flocking to the adhesive coating according to one embodiment of the present invention.

### DETAILED DESCRIPTION OF THE PREFERRED EMBODIMENTS

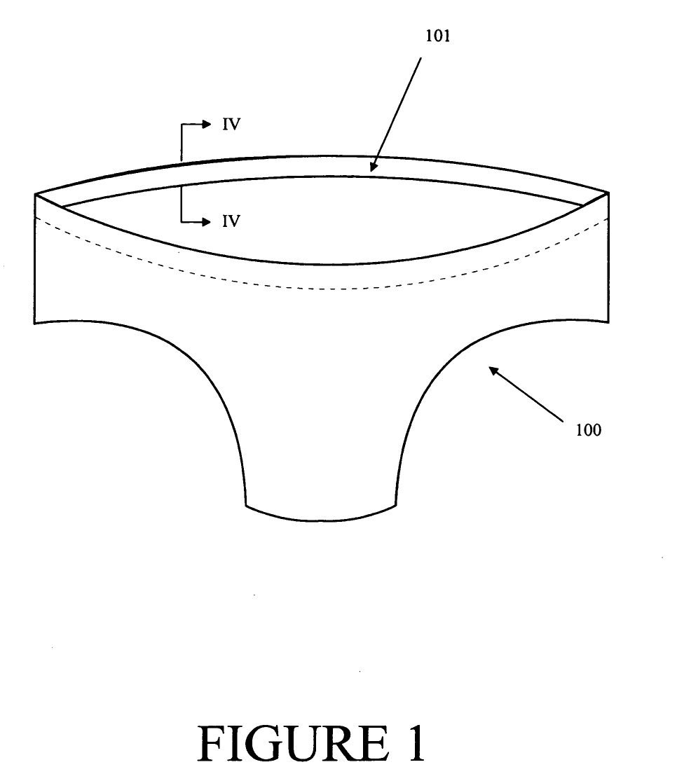

FIG. 1 shows a pair of panties 100 with a waistband 101 formed of an elastomeric adhesive on the side of the panties that faces the wearer's skin. The fabric of the panties 100 is preferably a stretchable material. The waistband 101 may be made of elastomeric adhesive, which may be silicone rubber or any other elastomeric adhesive suitable for coating the fabric, may be formed at the top of the panties and may replace both a traditional waistband and hem. The waistband 101 of elastomeric adhesive may extend to the edge of the fabric to prevent the unraveling of the fabric.

The application of an elastomeric adhesive coating on a specific area of a garment, such as the waistband of the pair of panties 100, may provide localized elastic properties which provide additional modulus to the garment as and where required. The wider the waistband or other support band of elastomeric adhesive coating of a given thickness, the greater the supporting force will be. Additional components of the panties 100, if desired, may be joined by the elastomeric adhesive, however the components may also be joined by thermal methods, seams, or any other method of joining pieces of fabric.

The elastomeric adhesive may be applied to the garment before the garment is finally cut to size. In a preferred embodiment, the cut may be made within the coated section to ensure even and complete coating of the garment. Alternatively, the elastomeric adhesive may be applied to the garment after it has been cut to size.

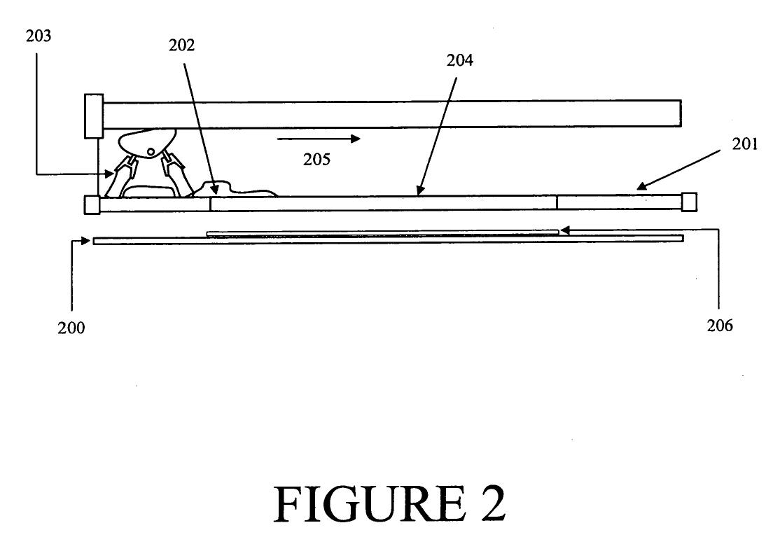

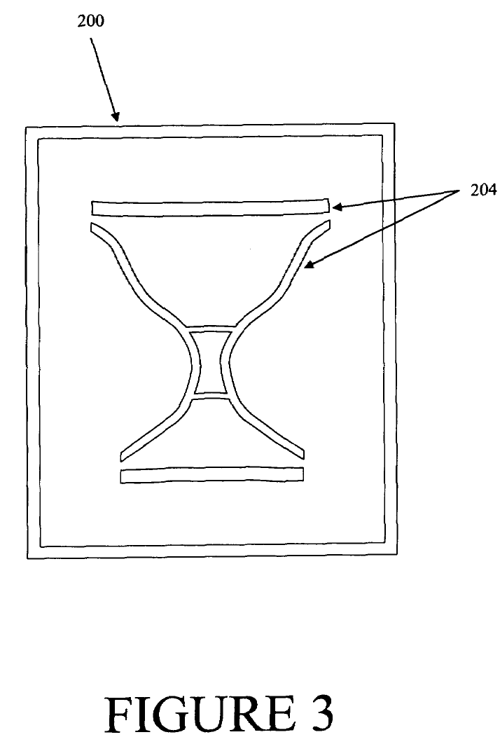

The application of the elastomeric adhesive to the garment may take place with a silkscreen configuration according to FIG. 2. A garment 200 may be placed beneath a silkscreen 201 on an area where an elastomeric adhesive coating is desired. FIG. 3 shows the top view of the silkscreen 201 with apertures 204. The elastomeric adhesive substance 202 may be passed through corresponding screen apertures 204 using squeegees 203, which may be moved in the direction of arrow 205. The elastomeric adhesive substance 202 that is in fluid contact with apertures 204 may be transferred to the garment 200 by capillary action in controlled and prescribed quantities to form an elastomeric adhesive coating 206 on the garment 200. Of course, apertures 204 may be provided in a wide variety of patterns and squeegees 203 may be operated in a number of orientations and directions.

Alternatively, the elastomeric adhesive may be sprayed onto the garment with or without the silkscreen 201. The thickness of the coating may vary, and depends on the type and configuration of the garment (e.g., the type of fabric used and the size of the garment), as well as customer requirements. The width of the bands may also vary, depending on the type and configuration of the garment, as well as customer requirements.

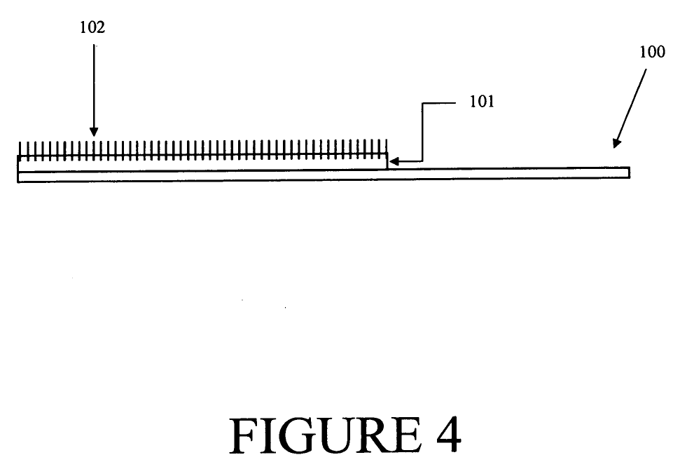

FIG. 4 shows a cross section of the waistband 101 with flocking 102 added for the comfort of the wearer. After the elastomeric adhesive coating is applied, the flocking 102 may be given an electrostatic charge and may then be attracted to the coated area by an opposite electrostatic charge induced in the coated garment. Alternatively, mechanical flocking may also be used to attach flocking to the adhesive coating. In one aspect, the flock fibers penetrate and embed themselves in the elastomeric adhesive coating and assume a position substantially perpendicular to the plane of the elastomeric adhesive coating, with one fiber end embedded in the coating and the other end of the fiber extending above the elastomeric coating. The elastomeric adhesive coating may then be cured, forming bonds with the flocking and the garments. The flocking may be the same color as the fabric or a contrasting color.

The fibers for the flocking 102 may be formed from any natural or synthetic material. Synthetic materials may include nylons, polyamides, polyesters such as terephthalate polymers and acrylic, and natural materials may include cotton, silk, rayon, and wool. A conductive coating or finish may be applied continuously or discontinuously over the exterior surface of the flocking fibers to permit the flocking fibers to hold an electrical charge.

The length of fiber used for flocking can be varied as appropriate. For example, a short or long length may be preferred. Additionally, the fibers may be linear or shaped. For example, the fibers may be curled, crimped, or bent. The fibers may be substantially perpendicular to the elastomeric adhesive coating, but, alternatively may be randomly oriented, angled between perpendicular and parallel orientations, or substantially parallel depending on a variety of design factors. The fibers used for flocking may be made by chopping or cutting a length of filament to a desired length. During the chopping or cutting, the fiber ends produced may be jagged or have multiple projections extending therefrom.

The flocking fibers may be attached to a sacrificial carrier layer or release sheet, with a release adhesive or binder applied to the carrier layer. The flocking fibers may then be transferred to the elastomeric adhesive by electrostatic or mechanical flocking.

In electrostatic flocking, the portion of the garment coated with the elastomeric adhesive may be passed through a fiber metering station in which an electrostatic field is maintained around the elastomeric adhesive, using, e.g., electrodes situated above and below the coated portion of the garment. The fibers may be applied to the elastomeric adhesive in the presence of the electrostatic field, which may orient the flocking fibers at a desired angle as they contact the elastomeric adhesive. The elastomeric adhesive may then be cured, anchoring the flocking.

Mechanical flocking may also be used to attach flocking to the elastomeric adhesive. In this aspect, the elastomeric adhesive may be coated with flocking by the beater-bar method. In a preferred aspect, the adhesive-coated portion of the garment may be passed over a series of polygonal rollers that rapidly vibrate that portion of the garment. This vibration may drive the fiber into the adhesive. The flocking fibers may then be delivered by a flock module for flat surfaces or by an airstream pump. Any excess and unattached fibers may be removed by vacuum.

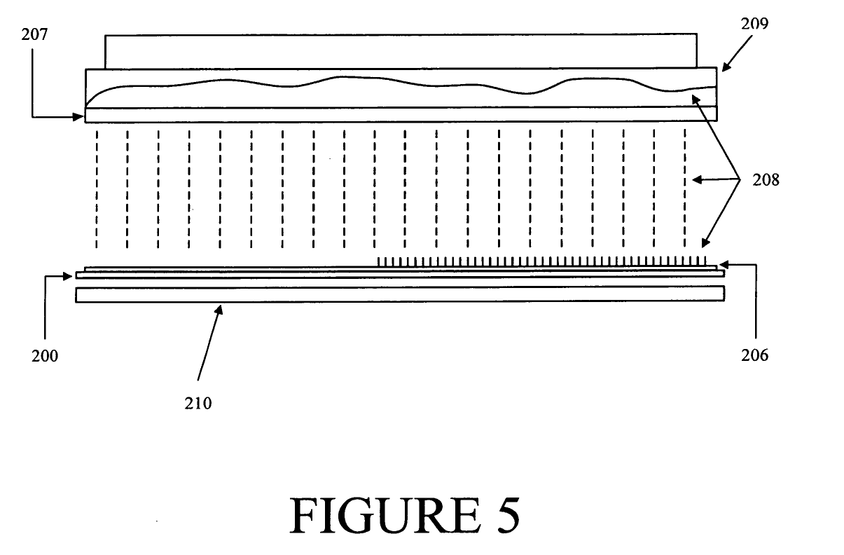

One aspect of the invention involves the application of charge to the flock fibers and attraction of the fibers to the elastomeric coating on the garment as is represented by the drawing provided in FIG. 5. A top inducer plate 207 may induce an electrostatic charge to the flock fibers 208 contained in a flock fiber storage compartment 209. A bottom inducer plate 210 may induce an opposite electrostatic charge to the coated garment 200, resulting in an electrostatic field between the coated garment 200 and the flock fibers 208. According to this aspect the flock fibers 208 are attracted to and move towards the garment 200 and penetrate and embed themselves in the elastomeric adhesive coating 206. In a preferred aspect, the fibers are oriented such that one fiber end is embedded in the elastomeric adhesive coating 206 and the other end of the fiber extends above the elastomeric adhesive coating 206 of the garment 200.

If heat curing is used with the elastomeric adhesive, the flocking may be protected by controlling the curing temperature and limiting the time the flocked garment is held in a dryer.

The principles, preferred embodiments, and modes of operation of the present invention have been described in the foregoing specification. The invention should not, however, be construed as limited to the particular forms disclosed, as these are to be regarded as illustrative rather than restrictive. Variations and changes may be made by those skilled in the art without departing from the spirit of the present invention. Accordingly, the foregoing best mode of carrying out the invention should be considered exemplary in nature and not as limiting to the scope and spirit of the invention as set forth in the appended claims.

The invention claimed is:

1. A garment comprising:
one or more panels of a stretchable fabric;
an elastomeric adhesive coating a portion of the fabric that would face the skin of a person wearing the garment; and
fiber flocking embedded in the elastomeric adhesive.

2. The garment of claim 1, wherein the elastomeric adhesive is silicone rubber.

3. The garment of claim 1, wherein the fiber flocking comprises fibers having first and second ends whereby the first end of the fibers are embedded in the elastomeric adhesive and the second ends of the fibers extend above the elastomeric adhesive.

4. The garment of claim 1, wherein the second ends of the fibers are substantially perpendicular to the plane of elastomeric adhesive.

5. The garment of claim 1, wherein the fiber flocking and elastomeric adhesive coating cover a waistband of the garment.

6. The garment of claim 1, wherein the fiber flocking and elastomeric adhesive coating cover edges of the garment.

7. The garment of claim 1, wherein second ends of the fibers of the fiber flocking are jagged.

8. The garment of claim 1, wherein second ends of the fibers of the fiber flocking have multiple projections extending therefrom.

9. A method of fabricating a garment comprising:
cutting one or more panels of a stretchable fabric to form the garment;
coating a portion of the fabric that would face the skin of a person wearing the garment with an elastomeric adhesive;
embedding one end of each fiber of fiber flocking within the elastomeric adhesive; and
curing the elastomeric adhesive.

10. The method of claim 9, wherein the fiber flocking is attracted to the elastomeric adhesive using electrostatic charges.

11. The method of claim 9, wherein the elastomeric adhesive is silicone rubber.

12. The method of claim 9, wherein the elastomeric adhesive and the fiber flocking cover a waistband of the garment.

13. The method of claim 9, wherein the elastomeric adhesive and the fiber flocking cover edges of the garment.

14. The method of claim 9, wherein the fibers of the fiber flocking are attached to a sacrificial carrier layer with a release adhesive applied to the carrier layer prior to embedding the fibers within the elastomeric adhesive.

15. The method of claim 10, wherein the portion of the garment coated with the elastomeric adhesive is passed through a fiber metering station in which an electrostatic field is maintained around the elastomeric adhesive.

16. The method of claim 15, wherein the electrostatic field is maintained around the elastomeric adhesive using electrodes situated above and below the coated portion of the document.

17. The method of claim 9, wherein the elastomeric adhesive is coated with flocking by the beater-bar method.

18. The method of claim 17, wherein the adhesive coated portion of the garment is passed over a series of polygonal rollers that vibrate the portion of the garment coated with the elastomeric adhesive.

19. The method of claim 10, wherein electrostatic charges in the fibers of the fiber flocking are induced by a top inducer plate and a bottom inducer plate inducing an opposite electrostatic charge to the portion of the garment coated with the elastomeric adhesive.

20. The method of claim 19, further comprising a flock fiber compartment, wherein the top inducer plate is installed in the flock fiber compartment.
